(19) United States
(12) Patent Application Publication
(10) Pub. No.: US 2024/0092194 A1
(43) Pub. Date: Mar. 21, 2024

(54) CHARGING DEVICE

(71) Applicant: Rivian IP Holdings, LLC, Plymouth, MI (US)

(72) Inventors: Michael Rosenblatt, Boulder, CO (US); David Day Lee, Bloomfield Hills, MI (US); Jeffrey Wei Doong, Redondo Beach, CA (US)

(21) Appl. No.: 17/932,352

(22) Filed: Sep. 15, 2022

(51) Int. Cl. B60L 53/16; B60L 53/18; B60L 53/65; G01S 17/08

(52) U.S. Cl. CPC B60L 53/16; B60L 53/18; B60L 53/65; G01S 17/08; G01S 17/89

(57) ABSTRACT

Various arrangements disclosed herein relate to dynamically determining a length of cable to provision for charging an electric vehicle, including a sensor to detect a characteristic of the electric vehicle, a data processing system configured to determine, based at least in part on the characteristic, a position of a charge port of the vehicle and to determine, based at least in part on the position of the charge port of the vehicle, a distance between a charging apparatus and the charge port of the vehicle. The charging apparatus includes a cable dispenser configured to provide a length of a segment of a cable based on the distance between the charging apparatus and the charge port.

### INTRODUCTION

Modern electric vehicles are powered by rechargeable batteries. Charging stations are dispersed throughout to provide facilities for recharging the batteries of different types of electric vehicles. A charge cable of a charge station can engage or otherwise mate with a charge port to supply power to the battery of the electric vehicle.

### SUMMARY

Inappropriate lengths (e.g., too long or too short) of charge cables used in charging electric vehicles can result in shorter lifetimes of the charging cables and therefore the charging apparatuses, increased cost of deployment of charging infrastructure, and poor user experience. To address such technical challenges, this disclosure is directed to systems, methods, and non-transitory computer-readable media for providing a charging cable of an appropriate length based on the design of an electric vehicle and the pose of the electric vehicle.

At least one aspect is directed to a system including a sensor to detect a characteristic of a vehicle and a data processing system. The data processing system is to determine, based at least in part on the characteristic, a position of a charge port of the vehicle and to determine, based at least in part on the position of the charge port of the vehicle, a distance between a charging apparatus and the charge port of the vehicle. The system also includes the charging apparatus having a cable dispenser, the cable dispenser is to provide a length of a segment of a cable based on the distance between the charging apparatus and the charge port.

At least one aspect is directed to a method including detecting, using a sensor, a characteristic of a vehicle, determining, based at least in part on the characteristic, a position of a charge port of the vehicle, determining, based at least in part on the position of the charge port of the vehicle, a distance between a charging apparatus and the charge port of the vehicle, and providing, using a cable dispenser, a length of a segment of a cable based on the distance between the charging apparatus and the charge port.

At least one aspect is directed to a non-transitory computer-readable medium storing computer-readable instructions thereon, such that when executed, causes at a processor to detect, using a sensor, a characteristic of a vehicle, determine, based at least in part of the characteristic, a position of a charge port of the vehicle, determine, based at least in part on the position of the charge port of the vehicle, a distance between a charging apparatus and the charge port of the vehicle, and provide, using a cable dispenser, a length of a segment of a cable based on the distance between the charging apparatus and the charge port.

At least one aspect is directed to a system including a vehicle having a battery, a sensor to detect a characteristic of a vehicle, a data processing system to determine, based at least in part of the characteristic, a distance between a charging apparatus and the charge port of the vehicle, and the charging apparatus including a cable dispenser. The cable dispenser is to provide a length of a segment of a cable based on the distance between the charging apparatus and the charge port.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle and a charging apparatus.

FIG. 2 depicts a system for charging an electric vehicle.

FIG. 3 is a diagram illustrating an example system for dynamically providing a length of cable for charging an electric vehicle.

FIG. 4 is a process flow diagram illustrating an example method for dynamically providing a length of cable for charging an electric vehicle.

FIG. 5 is a data flow diagram illustrating an example method for dynamically providing a length of cable for charging an electric vehicle.

FIG. 6 is a diagram illustrating a visual representation of a relative position of a charge port relative to reference points on an electric vehicle and relative positions of reference points on the electric vehicle relative to a position of the charging apparatus.

FIG. 7 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems for intelligent vehicle sensing to release known cable length. The various concepts introduced above and discussed in greater detail below may be implemented in any of numerous ways.

Electric vehicles are powered by batteries that can be recharged. Charging stations, including charging apparatuses, can recharge the batteries of electric vehicles. A cable of a charging apparatus can extend from the charging apparatus to a charge port of an electric vehicle and can engage with the charge port to supply power to the battery of the electric vehicle. Technical challenges concerning the cables include poor cable management caused by varying charge port positions on different vehicle models and different poses of electric vehicles when parked for charging, resulting in inappropriate lengths (e.g., too long or too short) of cables being used for charging the electric vehicles. Inappropriate lengths of cables can result in shorter lifetime of the charging apparatuses, increased cost of deployment of charging apparatuses, and poor user experience.

To address such technical challenges, this disclosure is directed to systems, methods, and non-transitory computer-readable media for providing a charging cable of an appropriate length based on the design of an electric vehicle and the position and orientation (e.g., pose) of the electric vehicle. An appropriate length of a segment of the cable can be determined for each charging instance, based on the design (e.g., vehicle model and maker) of the electric vehicle, the pose of the charge port of the electric vehicle, among other factors. By determining and optimizing the length of cable used to couple a charging apparatus with an electric vehicle the systems and methods described herein can increase usable cable lifetime, for example by controlling cable exposure to the elements and objects.

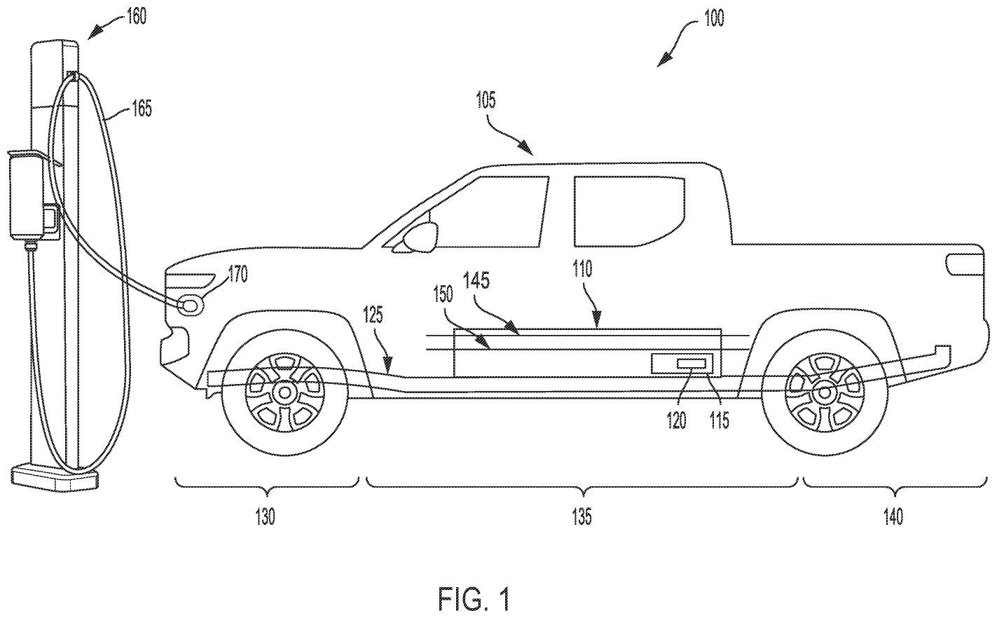

FIG. 1 depicts an example cross-sectional view 100 of an electric vehicle 105 installed with at least one battery pack 110, along with a charging apparatus 160. Electric vehicle such as the electric vehicle 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 (collectively referred to as the battery) to power the electric vehicles 105. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. The battery pack 110 can be installed on the chassis 125 of the electric vehicle 105 within one or more of the front portion 130, the body portion 135, or the rear portion 140. The battery pack 110 can include or connect with at least one busbar, e.g., a current collector element. The first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

The electric vehicle 105 can include a charge port 170, which is operatively coupled to and electrically connected with the battery (e.g., at least one of the board battery packs 110, battery modules 115, and battery cells 120) of the electric vehicle 105 for providing power thereto. For instance, the charge port 170 can be connected with the battery via one or more suitable wired or wireless electrical connections (e.g., an electrical wire, not shown) that can be internal to the electric vehicle 105. The charge port 170 is an interface between a power source of a charging apparatus 160 and the battery of the electric vehicle 105. The charge port 170 can include an electrical connector (also referred to as a socket) that is shaped, sized, and configured to mate with or detachably couple to an electrical connector (also referred to as a plug) on a charge cable 165. When the electrical connector of the charge cable 165 is appropriately mated with or coupled to the electrical connector of the charge port 170, electrical contacts from both of the electrical connector of the charge cable 165 and the electrical connector of the charge port 170 come in contact with one another and allow transfer of electricity by conduction, thus completing the electrical connection between a power source of the charging apparatus 160 and the battery of the electric vehicle 105. The electrical connectors of the charge cable 165 and the charge port 170 can be implemented using suitable electrical plug protocols, including Type 1, Type 2, GB/T, CHAdeMO, and so on. The charge port 170, the battery of the electric vehicle 105, and the charge cable 165 allow transfer of power via direct current (DC) or alternating current (AC). The charge port 170 can include a cover configured to be in a closed state to enclose the electrical connector of the charge port 170 when not charging and configured to be in an open state to expose the electrical connector of the charge port 170 when charging, so as to allow mating with the electrical connector of the charge cable 165.

The charge port 170 can have a fixed position on the electric vehicle 105, relative to the rest of the electric vehicle 105 (e.g., relative to one or more reference point, line, area, or volume of the electric vehicle 105). For example, FIG. 1 (among others) shows the charge port 170 located on the left side (driver side) in the front portion 130 of the electric vehicle 105, close to the front face of the electric vehicle 105, between the headlights and the front bumper. Other types of electric vehicles (e.g., other models) can have different positions. A charge port can be located in the front portion 130, the body portion 135, the rear portion 140, the front face (on which headlights are provided), the rear face (on which taillights are provided), on the left side (driver side), on the right side (passenger side), in the trunk, on the roof, on the bottom surface, and so on. The position of the charge port 170 on the electric vehicle 105 can be defined by a point, a line, an area, or a volume, each of which can be specified using at least one set of coordinates (e.g., (x, y) or (x, y, z)) or at least one function (e.g., f(x, y) or f(x, y, z)) in a 2-dimensional or 3-dimensional coordinate system (e.g., the Cartesian system). An outline, contour, exterior, and point/line/area/volume of interest on the electric vehicle 105 can also be defined using a set of coordinates or at least one function in the same 2-dimensional or 3-dimensional coordinate system (e.g., the Cartesian system). In that regard, the position of the charge port 170 can be determined relative to any point, line, area, or volume of the electric vehicle 105. As discussed in further detail herein, the relative position of the charge port 170 (e.g., a point) relative to a reference point can be defined using a vector originating from the reference point to the point defining the charge port 170.

The locations of the charge ports 170 on the electric vehicles 105 vary from vehicle to vehicle. For example, different makes and models of electric vehicles 105 can have charge ports 170 located in different areas. Electric vehicles 105 can also park in different positions or orientations (e.g., different poses) with respect to the charging apparatus 160 for a charging session. The different poses can be caused by the direction in which the electric vehicle 105 is parked (e.g., head-in or tail-in), the angle by which the electric vehicle 105 is parked, or the distance between the electric vehicle 105 and the charging apparatus 160, for example. Thus, the length of the cable 165 deployed to charge electric vehicles 105 can vary significantly based for example on vehicle model or vehicle pose.

Cables 165 that can charge electric vehicles 105 can be heavy or unwieldy for some users. To mechanically couple the charging connector (plug) to with the charge port 170 (vehicle socket), a user moves the charging connector and the cable 165 attached thereto in Cartesian directions as well as roll-pitch-yaw directions. Providing more length of the charging cable 165 than needed to charge a particular electric vehicle 105 results in increased degradation of the charging cable 165 and the charging apparatus 160, thus considerably increasing the cost of mass deployment of public charging infrastructures. The surplus length of the charging cable 165 can clutter the parking space, making it inconvenient for the user to perform actions related to charging.

The present disclosure is directed to systems, methods, and non-transitory computer-readable media for providing a charging cable 165 of an appropriate length based on the design of the electric vehicle 105 and the pose of the electric vehicle 105 as parked for charging. The implementations disclosed herein bridge spatial constraints caused by varying locations of charge ports on electric vehicles and different poses of electric vehicles as they are parked for charging.

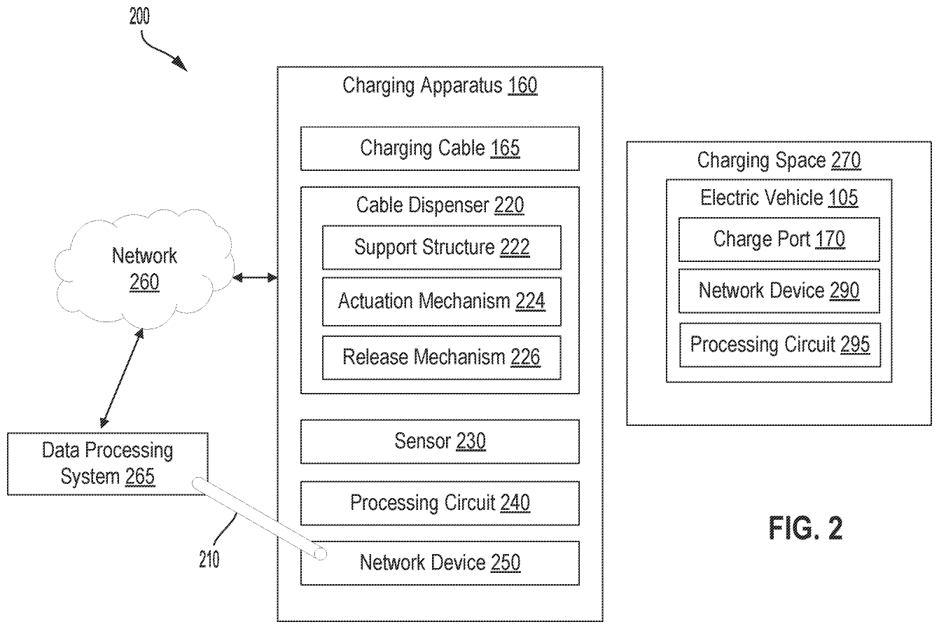

As shown in FIG. 2, among others, a system 200 includes a charging apparatus 160 used to charge an electric vehicle 105. The charging apparatus 160 may also be known as a charging station, charging hub, charging waypoints, and so on. A public charging location can include multiple charging apparatuses 160, each of which can be used to charge a respective electric vehicle 105. A public charging infrastructure network can include multiple public charging locations.

The charging apparatus 160 can include a charging cable 165, a cable dispenser 220, a sensor 230, a processing circuit 240, and a network device 250. The electric vehicle 105 can park in a charging space 270 in a pose (e.g., position and orientation) when being charged by the charging apparatus 160. The electric vehicle 105 includes a charge port 170, a network device 290, and a processing circuit 295. The charging apparatus 160 can be located at any position relative to the charging space 270. The charging apparatus 160 can be attached to or embedded in a wall, floor, ceiling, or can be a hub adjacent to the charging space 270.

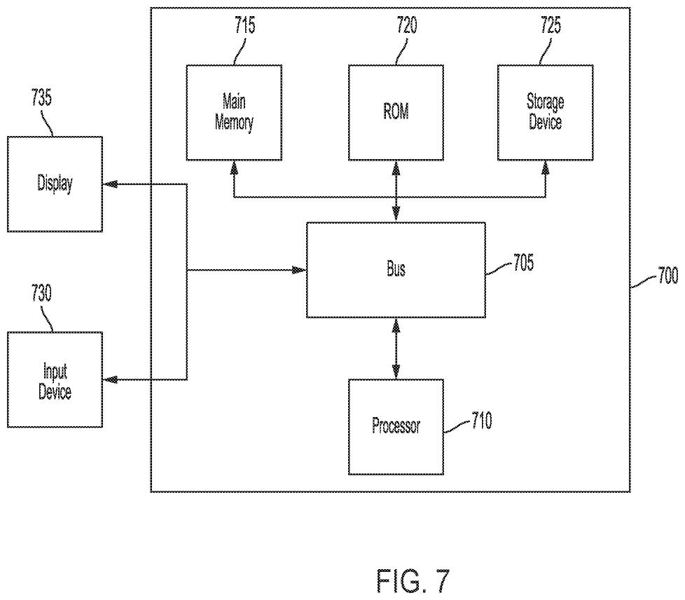

The processing circuit 240 can include at least one processor and at least one memory for performing functions of the processing circuit 240, including executing the software and firmware of the charging apparatus 160 and any component thereof. The processing circuit 240 can include the computer system 700 (FIG. 7, among others). The processing circuit 240 can control and implement the functions for the cable dispenser 220, the sensor 230, the network device 250, and other features of the charging apparatus 160. For instance, the processing circuit 240 can provide data processing and data storage functionalities for the cable dispenser 220, the sensor 230, the network device 250, and other features of the charging apparatus 160.

The processing circuit 295 can include at least one processor and at least one memory for performing functions of the processing circuit 295, including executing the software and firmware of the electric vehicle 105 and any component thereof. The processing circuit 295 can include the computer system 700 (FIG. 7, among others). The processing circuit 240 can control and implement the functions for the charge port 170, the network device 290, and other features of the electric vehicle 105 (e.g., battery control, steering, charging, locomotion, etc.). For instance, the processing circuit 295 can provide data processing and data storage functionalities for the charge port 170, the network device 290, and other features of the electric vehicle 105.

The data processing system 265 includes computing and memory storage resources located remote from the charging apparatus 160 and the electric vehicle 105, and is connected to the charging apparatus 160 and the electric vehicle 105 via a network 260. The data processing system 265 can include a large amount of computing and memory storage resources in aggregate, thus can perform computational tasks more complex in more efficient matter than those that can be performed using the processing circuit 240 or 295. The processing circuits 240 and 295 can send computing and storage tasks to the data processing system 265 via the network 260, to leverage the computing and memory storage capabilities of the data processing system 265. The data processing system 265 can include one or more computing systems that are remote from the charging apparatus 160 and the electric vehicle 105. For example, the data processing system 265 can be at least one third-party cloud computing system each including one or more datacenters. Each datacenter includes computing and memory storage resources (e.g., processors and memories) configured for computing and storage tasks, respectively. The data processing system 265 can include at least one third-party computing system or device (e.g., mobile devices, smart phones, tables, other electric vehicles, smart appliances, public computing infrastructures, and so on) that each includes computing and memory storage resources (e.g., processors and memories) configured respectively for computing and storage tasks and have the appropriate interface (e.g., Application Programming Interfaces (APIs), applications, and so on) that supports connection and communication with the charging apparatus 160 and the electric vehicle 105.

In some examples, the data processing system 265 can include the processing circuit 240, processing circuit 295, and the computing and memory storage resources located remote from the charging apparatus 160 and the electric vehicle 105, or a combination of two or more of the processing circuit 240, the processing circuit 295, and the computing and memory storage resources located remote from the charging apparatus 160 and the electric vehicle 105. The data processing described herein can be performed by the charging apparatus 160, by the electric vehicle 105, by the computing and memory storage resources located remote from the charging apparatus 160 and the electric vehicle 105, or by a combination of two or more of those entities in a distributed processing scenario, among other examples.

The network device 250 can include hardware, software, and firmware used in communicating with another network entity (e.g., the computing and memory storage resources located remote from the charging apparatus 160 and the electric vehicle 105 of the data processing system 265, the network device 290 of the electric vehicle 105, and so on) over a communication network. Examples of communication networks include a local area network (LAN) and a wide area network (WAN), an inter-network (e.g., the Internet), and peer-to-peer networks (e.g., ad hoc peer-to-peer networks). In that regard, the network device 250 can include one or more antennas and one or more baseband processors for controlling the antennas for sending and receiving signals. The network device 250 can communicate using a long-range network (e.g., 5G) or a short-range network (e.g., Radio Frequency Identification (RFID), Bluetooth, WiFi, etc.).

The network device 290 can include hardware, software, and firmware used in communicating with another network entity (e.g., the computing and memory storage resources located remote from the charging apparatus 160 and the electric vehicle 105 of the data processing system 265, the network device 290 of the electric vehicle 105, and so on) over a communication network. In that regard, the network device 290 can include one or more antennas and one or more baseband processors for controlling the antennas for sending and receiving signals. The network device 290 can communicate using a long-range network (e.g., 5G) or a short-range network (e.g., RFID, Bluetooth, WiFi, etc.).

The sensor 230 can capture or output sensor data of or in relation to the electric vehicle 105. The sensor data is an example of the characteristic of the electric vehicle 105. The sensor 230 can include one or more of a camera, infrared sensor, Light Detection and Ranging (LIDAR), or spatial data sensor, for example. The sensor data can include at least one of video, image, LIDAR, or spatial data, for example. The sensor 230, which can include multiple sensors, can provided on or within a housing of the charging apparatus 160. The sensor 230 can be provided within, around, above, or under the charging space 270. The sensor 230 is arranged at a position on or adjacent to the charging apparatus 160, with a sufficiently unobstructed clear field of view (FOV) on at least a portion of or the entirety of the charging space 270 and at least a portion of or the entirety of any vehicle parked in the charging space 270, to allow the sensor 230 to capture or output the sensor data of or in relation to the electric vehicle 105.

The charging cable 165 can be any suitable charging cable used in the electric vehicle context. The charging cable 165 can include one or more electrical wires encased by a suitable insulating material such as rubber. The materials of the charging cable 165 can be sufficiently pliable or flexible to allow physical manipulation applied to the charging cable 165 when the charging cable 165 is stored within a storage space in the charging apparatus 160, when the charging cable 165 is retrieved or dispensed, and when the charging cable 165 is charging the battery of the electric vehicle 105.

The cable dispenser 220 can includes a support structure 222 that physical supports the charging cable 165. The support structure 222 can include one or more of a spool, spindle, reel, rack, hook, container, and so on that allows storing and managing of the charging cable 165. The cable dispenser 220 includes an actuation mechanism 224 that controls the support structure 222 or the charging cable 165 to dispense the charging cable 165 from the support structure 222 and retrieve the charging cable 165 to be stored in or on the support structure 222. The actuation mechanism 224 can spin the support structure 222 (e.g., a spool) in one direction to dispense the charging cable 165 (reel outward) and in the opposite direction to retrieve the charging cable 165 (reel inward). The actuation mechanism 224 includes active mechanical element such as one or more motors to provide motion to the support structure 222 or the charging cable 165. The cable dispenser 220 includes a release mechanism 226 that can arrest, lock, prevent, or provide resistance for the moment of the charging cable 165, for example, in response to the data processing system 265 determining that the determined length of the segment of the charging cable 165 has been dispensed. The release mechanism 226 includes one or more of a clamp, lock, pin, bolt, buckle, clasp, clip, latch, hook, pegs, roller, and so on. The release mechanism 226 is located on the actuation mechanism 224 or the support structure 222 and can prevent or provide resistance for the actuation mechanism 224 from actuating the support structure 222 or the charging cable 165. The release mechanism 226 can include a pin that can be automatically inserted to halt the spinning of the spool in response to the data processing system 265 determining that the determined length of the segment of the charging cable 165 has been dispensed. The release mechanism 226 can include a clamp, clip, or latch that applies pressure to a portion of the charging cable 165 to stop or increase resistance for further provision of the charging cable 165. The forces applied to prevent further provision of the charging cable 165 is greater than the forces applied to increase resistance for further provision of the charging cable 165. Increasing resistance allows the user to become aware that the charging cable 165 is not intended to be dispenses further. The actuation mechanism 224 can control the support structure 222 (e.g., a gantry, crane, robotic arm, etc.) to move the charging cable 165 including the electrical connector (e.g., plug) in any suitable direction in space (e.g., in the Cartesian coordinate system). The actuation mechanism 224 can control the support structure 222 to move the charging cable 165 including the electrical connector adjacent to the charge port, extending the charging cable 165 the length of the segment of the charging cable 165. The actuation mechanism 224 can control the support structure 222 (e.g., a gantry, crane, or robotic arm) to insert the electrical connector of the charging cable 165 into the charge port, extending the charging cable 165 the length of the segment of the charging cable 165 in the process. The data processing system 265, or the processing circuit 240 controls the functions of the actuation mechanism 224 and the release mechanism 226.

The data processing system 265 can determine a length of a segment of the charging cable 165 that used to couple the electric vehicle 105 to the charging apparatus 160 to transfer power from the charging apparatus 160 to the electric vehicle 105. The length of the segment of the charging cable 165 can be determined based at least in part on a position of the charge port 170 of the electric vehicle 105 relative to the charging apparatus 160 (e.g., relative to a first position of the charging cable 165).

The data processing system 265 can determine a vehicle model of the electric vehicle 105 based on the characteristic (e.g., sensor data). The processing circuit 240 can determine the vehicle model of the electric vehicle 105 based on the characteristic, or the network device 250 can also send the characteristic to the data processing system 265, which can determine the vehicle model of the electric vehicle 105 based on the characteristic. The data processing system 265 can compare and correlate the characteristic with vehicle model data (e.g., characteristics) of plurality of vehicle models stored in a vehicle model database based on image recognition, artificial intelligence (AI), etc. In other words, based on the characteristic, the electric vehicle 105 is matched to or correlated with one of the plurality of vehicle models. The vehicle model is accordingly identified.

The electric vehicle 105 can also, via the network device 290 and through a long-range network (e.g., 5G), transmit a charging request to reserve the charging space 270 associated with the charging apparatus 160. The charging request can include an identifier indicating (directly or indirectly) the vehicle model of the electric vehicle 105. The electric vehicle 105 can, via the network device 290 and through a short-range network (e.g., RFID, Bluetooth, WiFi, etc.), transmit an identifier indicating (directly or indirectly) the vehicle model of the electric vehicle 105.

The position of the charge port 170 can be in the form of an identified point, area, or volume within a representation of an electric vehicle in an 2D (e.g., x-y, x-z, or y-z) space or 3D (e.g., x-y-z) volume. The position of the charge port 170 can be in the form of an identified point, area, or volume in a vector (e.g., distance and direction) relative to a given reference point, area, or volume of an electric vehicle.

The pose (e.g., position and orientation) of the electric vehicle 105 as it is parked within the charging space 270 is determined. In other words, the parking geometry of the electric vehicle 105 within the charging space 270 is determined. The sensor 230 can capture the characteristic (e.g., images, videos, LIDAR data, spatial data, etc.) of the electric vehicle 105, which can be used to determine the pose of the electric vehicle 105. The data processing system 265 can determine the distance of the charge port 170 of the electric vehicle 105 relative to the charging apparatus 160 (e.g., a first position of the charging cable 165) based on the position of the charge port 170 on the electric vehicle 105 and the pose of the electric vehicle 105 as it is parked within the charging space 270. The charging space 270 may include vehicle location measures such as stops, wheel walls, etc. that ensures that a reference point or side (e.g., front bumper, side bumper, etc.) of the electric vehicle 105 is at a particular position relative to the charging apparatus 160 (e.g., a first position of the charging cable 165). In that regard, the position and orientation can be assumed based on the vehicle model of the electric vehicle 105.

The charging apparatus 160 provides a segment of the charging cable 165 with the determined length can be provided. The actuation mechanism 224 can dispend (e.g., extend) the charging cable 165 from the charging apparatus 160 (e.g., from the support structure 222). The actuation mechanism 224 can provide only the determined length, and the release mechanism 226 stops further provision of (e.g., locks) the charging cable 165 past the determined length. The cable dispenser 220 passively allows the charging cable 165 to be retrieved (e.g., pulled) by a user, and the release mechanism 226 stops further provision of (e.g., locks) the charging cable 165 past the determined length. The actuation mechanism 224 can provide motor-assisted retrieval by a user, and the release mechanism 226 stops further provision of (e.g., locks) the charging cable 165 past the determined length.

The actuation mechanism 224 can retract or otherwise withdraw the charging cable 165 and store the same in the support structure 222. For example, in response to detecting a withdraw trigger event, the actuation mechanism 224 can, without user assistance, retract or otherwise withdraw the charging cable 165 toward the support structure 222 and return the charging cable 165 to the first position. Examples of the withdraw trigger event include determining by the processing circuit 240 that the charging has been completed or receiving by the processing circuit 240 user input (received using a user input device such as the user input device 730 on the charging apparatus 160 or received as a message from the electric vehicle 105 over a network) corresponding to a user decision to terminate the charging session. The actuation mechanism 224 can withdraw or allow withdrawal of the determined length of the segment of the cable back to the first position using the motor assistance. The user can physically move or triggering moving of the charging cable 165 back to the first position with motor assistance from the actuation mechanism 224. The release mechanism 226 can release, unlock, or loosen any resistance or lock on the charging cable 165 by releasing one or more of the clamp, lock, pin, bolt, buckle, clasp, clip, latch, hook, pegs, or roller holding the charging cable 165 in place. The actuation mechanism 224 can provide motor assistance to retrieve or withdraw the charging cable 165 in response to releasing, unlocking, or loosening the resistance or lock on the charging cable 165.

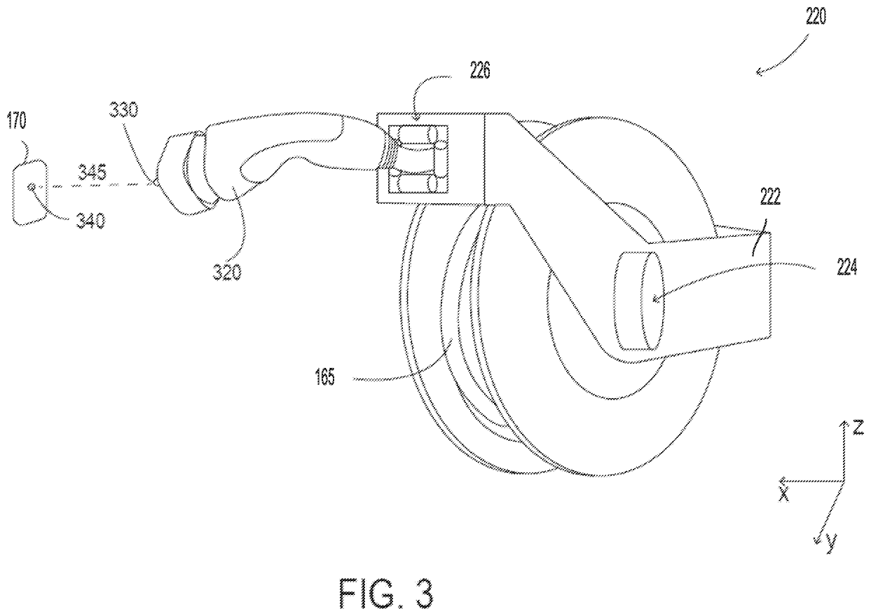

FIG. 3 is a diagram illustrating an example cable dispenser 220 to dynamically provide a length of a charging cable 165 for charging an electric vehicle (e.g., the electric vehicle 105). The cable dispenser 220 can include a support structure 222, an actuation mechanism 224, and a release mechanism 226. The support structure 222 is an example and can include a spool. Other examples of the support structure 222 can include a spindle, reel, rack, hook, container, and so on. The actuation mechanism 224 is an example and can include a motor driving the support structure 222. The release mechanism 226 is an example and can include multiple rubber rollers, which can be driven by at least one motor not shown or can be passive (e.g., no motor). The cable dispenser 220 can dispense, retrieve, or maintain the charging cable 165, which is an example of the charging cable 165.

A first position 330 of the charging cable 165 can be predetermined. As shown in FIG. 3, among others, the first position 330 corresponds to a tip of the electrical connector (e.g., plug) 320 located at the end of the charging cable 165, when the entire length of the charging cable 165 is retrieved and wind around the support structure 222. This can also be an initial state or resting state of the charging cable 165. In other words, the first position 330 is a position on the charging cable 165 when no length of the charging cable 165 has been provided. The first position 330 can be any predefined a point along the charging cable 165 when no length of the charging cable 165 has been provided. For example, the first position can also be at the opposite end of the electrical connector 320. The first position 330 can be a point that is closest to the electric vehicle 105 when the electric vehicle 105 is parked in the charging space 270.

The charging cable 165 is wind around the support structure 222 when in the first position 330. The actuation mechanism 224 can rotate the support structure 222 in one direction (e.g., clockwise direction) to dispense charging cable 165 and rotate the support structure 222 in another direction (e.g., counter-clockwise direction) to withdraw the charging cable 165. The release mechanism 226 is shown as rubber rollers that remains passive when the charging cable 165 is being dispensed to allow the charging cable 165 to move past the rubber rollers. The release mechanism 226 can lock or arrest the charging cable 165 in place when the determined length of the segment of the charging cable 165 has been provided, by locking the rubber rollers in place (e.g., by inserting one or more pins or engaging one or more locks to prevent or increase resistance for rotation or other movement of the rubber rollers). The friction on the surfaces of the stationary rubber rollers prevents or increase resistance for further dispensing of the charging cable 165. The actuation mechanism 224 can also stop moving the support structure 222, thus locking the charging cable 165. When the actuation mechanism 224 remains stationary and locks in place, the support structure 222 and therefore the charging cable 165 also stop moving. Both the actuation mechanism 224 and the release mechanism 226 can lock the charging cable 165 in response to the data processing system 265 determining that the determined length of the segment of the charging cable 165 has been dispensed, to resist the user from pulling additional segments of the charging cable 165.

The distance 345 between the first position 330 of the charging cable 165 and the position 340 of the charge port 170 of an electric vehicle 105 is determined using suitable methods disclosed herein. The rest of the electric vehicle 105 is not shown for clarity. As shown, the position 340 of the charge port 170 can be defined as a center point in an exterior surface of a cover of the charge port 170. The position of the charge port 170 can be defined to correspond to another suitable point associated with the charge port 170. For example, the position of the charge port 170 can be defined by a lowest point of the cover of the charge port 170, a highest point cover of the charge port 170, a point at a corner of the cover of the charge port 170, and so on.

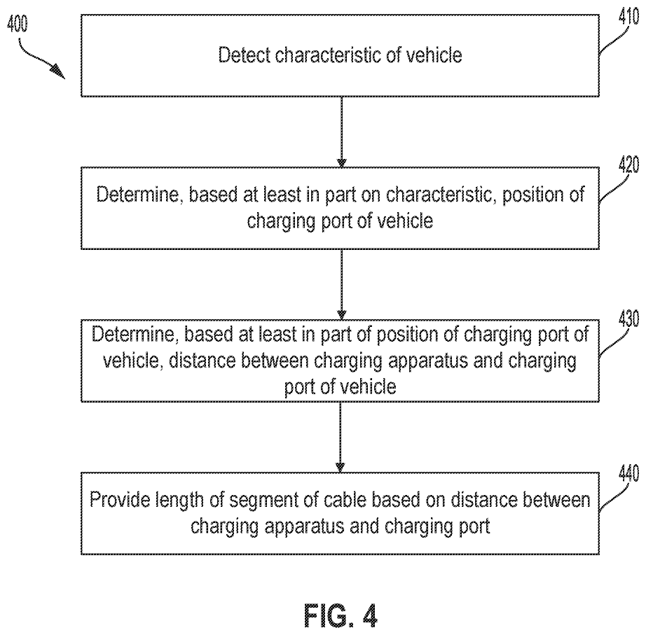

FIG. 4 is a flowchart diagram illustrating an example method 400 for dynamically providing a length of cable for charging an electric vehicle. At 410, the sensor 230 detects a characteristic of a vehicle (e.g., the electric vehicle 105). The sensor includes at least one of a camera (e.g., at least one camera), an infrared sensor (at least one infrared sensor), a LIDAR system (e.g., at least one LIDAR transmitter and at least one LIDAR receiver), and a spatial data sensor (e.g., at least one spatial data sensor). The characteristic includes at least one of an image (e.g., image data), video (e.g., video data), LIDAR data, spatial data, and so on. The characteristic can include any output data of the sensor, such as the image data, video data, LIDAR data, and spatial data. The data processing system 265 can process the characteristic to determine position information of the electric vehicle 105 and the charge port of the vehicle, in relation to the charging apparatus or the first position of the charging cable.

The characteristic indicates or corresponds to a particular design for an electric vehicle, such as a vehicle model or a vehicle maker. The vehicle model serves as an identifier for a type of vehicles, where the exterior structures of all vehicles of the same type can have the same shape and size. For example, the charge ports of all vehicles of the same type can have the same shape and size charge port, and the fixed position of the charge port relative to the rest of the vehicle remains the same for all vehicles of the same type. For example, each vehicle having the same design (e.g., the same model) has a charge port (defined by a point, line, area, or volume) at a known position relative to the rest of the vehicle. Accordingly, prior knowledge of the known positions of the charge ports of different models of vehicles can be leveraged for effective and efficient determination of the position of the charge port relative to the rest of the vehicle.

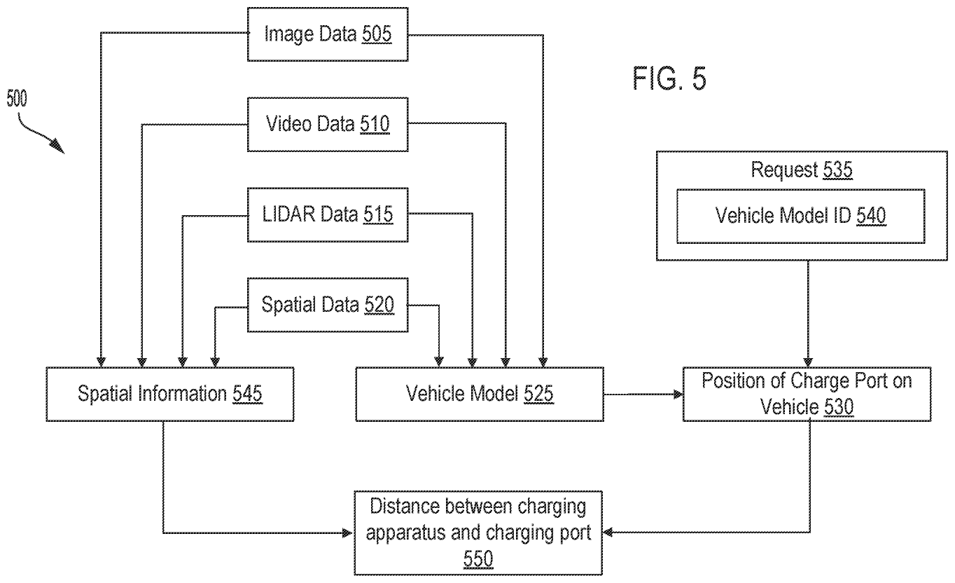

At 420, the data processing system 265 can determine, based at least in part on the characteristic, a position (e.g., the position 340) of a charge port (e.g., the charge port 170) of the vehicle 105. In some examples in which the characteristic indicates a type of vehicles (e.g., a vehicle model), the data processing system 265 can determine the vehicle model of the vehicle based on the characteristic. Given that the distance between the charging apparatus 160 and the charge port 170 of the vehicle 105 is determined based on the position 340 of the charge port 170 (e.g., at 430), and that the vehicle model can be used to derive the position 340 of the charge port 170 on the type of vehicles corresponding to the vehicle model, the data processing system 265 can determine the distance between the charging apparatus and the charge port of the vehicle based at least in part on the vehicle model of the vehicle. FIG. 5 is a data flow diagram illustrating an example method 500 for dynamically providing a length of cable for charging an electric vehicle. As shown in FIG. 5, among others, the sensor 230 outputs or otherwise provides characteristic of the electric vehicle 105, including one or more of image data 505, video data 510, LIDAR data 515, and spatial data 520. Based on such characteristic, the data processing system 265 can determine the vehicle model 525 in the manner described.

The data processing system 265 can correlate the vehicle with a vehicle model based at least in part on the characteristic of the vehicle and vehicle model data obtained from a vehicle model database. For example, a vehicle model database storing vehicle model data (e.g., characteristics) of plurality of vehicle models can be provided. The vehicle model database can store, for each vehicle model, image data, video data, LIDAR data, and spatial data captured by one or more corresponding sensors for different angles and distances relative to one or more representative vehicles of that vehicle model, under various weather conditions, lighting, etc. The characteristic of the electric vehicle 105 is compared or correlated with the characteristics of the plurality of vehicle models. The data processing system 265 can compare one or more corresponding types of characteristic of the vehicle 105 and the characteristic of the plurality of vehicle models. For example, the image data of the vehicle 105 can be compared with the image data of the plurality of vehicle models. The LIDAR data and the video data of the vehicle 105 can be compared with the LIDAR data and the video data of the plurality of vehicle models. One of the plurality of vehicle models having the highest correlation score can be selected as the vehicle model of the electric vehicle 105. The data processing system 265 can implement AI (e.g., a classifier) trained using supervised, unsupervised, or deep learning to classify the characteristic of the electric vehicle 105 as belong to one of the plurality of vehicle models. The AI can be trained using a dataset that can include, for each vehicle model, image data, video data, LIDAR data, and spatial data captured by one or more corresponding sensors for different angles and distances relative to one or more representative vehicles of that vehicle model, under various weather conditions, lighting, etc.

As shown in FIG. 5, among others, the vehicle model 525 can be determined using the request 535. An example of the request 535 is the charging request sent by the network device 290 of the electric vehicle 105 to the network device 290, using long-range network or short-range network. The request 535 includes the vehicle model ID 540, which can identify the vehicle model explicitly. In other examples, the vehicle model ID 540 can identify the vehicle model implicitly, allowing the data processing system 265 to determine the vehicle model based on the vehicle model ID 540. The vehicle model ID 540 may be a vehicle identification number (VIN). The data processing system 265 queries a relevant database (e.g., a Department of Motor Vehicle database) using the VIN as input to retrieve the vehicle model information. Accordingly, the network device 250 is configured to receive from the electric vehicle (e.g., the network device 290) a charging request (e.g., the request 535) which includes an indication (e.g., the vehicle model ID 540) of a vehicle model of the electric vehicle. The data processing system 265 can determine the distance between the charging apparatus and the charge port based at least in part on the vehicle model of the vehicle in the manner described.

The position of the charge port on the vehicle 530 can be determined based on the vehicle model 525 or the vehicle model ID 540 which indicates the vehicle model. For instance, the data processing system 265 can determine the relative position of the charge port on the vehicle relative to a reference point, reference line, reference area, or reference volume of the vehicle.

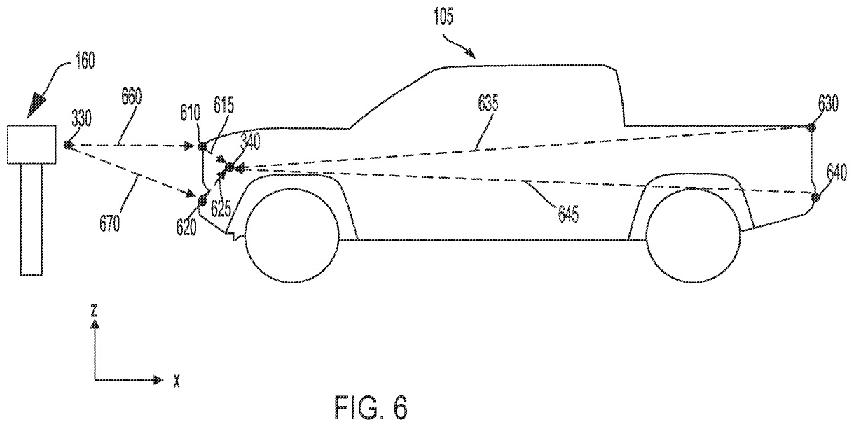

FIG. 6 is a diagram illustrating a visual representation of a relative position 340 of a charge port 170 relative to reference points 610, 620, 630, and 640 on an example electric vehicle 105. In response to determining the vehicle model ID 540, the data processing system 265 can query a vehicle design database that stores, for each vehicle model of a plurality of known vehicle models, a relative position of a charge port relative to at least one reference point on each vehicle model. In the example shown in FIG. 6, among others, the data processing system 265 can retrieve from the vehicle design database a set of coordinates (e.g., in the x-z coordinate system) for the position 340 of the charge port 170 and a set of coordinates of each of the reference points 610, 620, 630, and 640. The data processing system 265 can retrieve from the vehicle design database one or more vectors 615, 625, 635, and 645 from a respective one of the reference points 610, 620, 630, and 640 to the position 340 of the charge port. While FIG. 6 illustrates coordinates and vectors in a 2-dimensional representation, similar concepts can be applied in a 3-dimensional representation. While FIG. 6 illustrates a reference point for the charge port 170 and reference points for the rest of the electric vehicle 105, c for the charge port 170 and the data processing system 265 can retrieve from the vehicle design database on the rest of the electric vehicle 105 can be similarly implemented. For instance, each of a reference line, reference area, or reference volume can be defined using a collection of points or a function in the coordinate system. Accordingly, the relative position 340 of the charge port 170 on the electric vehicle 105 relative to a reference point, reference line, reference area, or reference volume of the vehicle can be determined by the digital processing system.

The digital processing system can determine the relative position of the reference point, reference line, reference area, or reference volume of the electric vehicle 105 (e.g., one or more of the reference points 610, 620, 630, and 640) relative to the position of the charging apparatus 160 (e.g., the first position 330 of the charging cable 165). The characteristic (e.g., one or more of the image data 505, the video data 510, the LIDAR data 515, and the spatial data 520) indicates the spatial information 545 of the electric vehicle 105, which is currently parked in the charging space 270. The data processing system 265 can determine the spatial information of the vehicle based at least in part of the characteristic, and the data processing system 265 can accordingly determine the length of the segment of the cable based at least in part on the spatial information of the electric vehicle 105.

In the example shown in FIG. 6, among others, the digital processing system can determine the positions of one or more of the reference points 610, 620, 630, and 640 relative to the first position 330 using the characteristic. For example, the digital processing system can determine a contour of the electric vehicle 105, including any reference points 610, 620, 630, and 640) using at least one LIDAR sensor, based on the output (e.g., a point cloud) of the LIDAR sensor and the location of each of the LIDAR sensor. The digital processing system can determine a contour of the electric vehicle 105, including any reference points 610, 620, 630, and 640) using at least one spatial sensor, based on the output (e.g., depth data) of the spatial sensor and the location of the spatial sensor. The digital processing system can use the image data from two or more cameras or video data from two or more video cameras to determine, based on the locations of the cameras and video cameras, a contour of the electric vehicle 105, including any reference points 610, 620, 630, and 640). In some examples, AI can be trained using a dataset that can include, for different poses of different vehicles, image data, video data, LIDAR data, and spatial data captured by one or more corresponding sensors for different angles and distances relative to one or more representative vehicles of that vehicle model, under various weather conditions, lighting, etc. The trained AI, controlled by the digital processing system, can determine the contour of the electric vehicle 105, including any reference points 610, 620, 630, and 640), using any input image data, video data, LIDAR data, and spatial data.

The data processing system 265 can determine a set of coordinates (e.g., in another x-z coordinate system) corresponding to the first position 330 of the charging apparatus 160 and a set of coordinates of each of the one or more reference points 610, 620, 630, and 640. The data processing system 265 can determine a vector 660 or 670 from first position 330 to the reference points 610 and 620.

The data processing system 265 can determine the distance between the charging apparatus 160 and the charge port 170 of the electric vehicle 105 based at least in part on the vehicle model of the vehicle by determining the relative position of the charge port 170 on the electric vehicle 105 relative to a reference point, reference line, reference area, or reference volume of the electric vehicle 105, determining the relative position of the reference point, reference line, reference area, or reference volume of the electric vehicle 105 relative to the position of the charging apparatus 160 (e.g., the first position 330 of the charging cable 160), and determining the relative distance between the position 340 of the charge port 170 relative to the position 330 of the charging apparatus 160 using the relative position 340 of the charge port 170 to the reference point, reference line, reference area, or reference volume of the electric vehicle 105 and the relative position of the reference point, reference line, reference area, or reference volume of the electric vehicle 105 relative to the position of the charging apparatus 160 (e.g., the first position 330 of the charging cable 165).

At 430, the data processing system 265 can determine, based at least in part on the position 340 of the charge port 170 of the electric vehicle 105, a distance (e.g., the distance 345) between the charging apparatus 160 and the charge port 170 of the electric vehicle 105. The data processing system 265 can determine the distance between the charging apparatus 160 and the charge port 170 of the electric vehicle 105 based at least in part on the vehicle model of the electric vehicle 105. For example, the data processing system 265 can determine the relative position 340 of the charge port 170 on the electric vehicle 105 relative to a reference point, reference line, reference area, or reference volume of the electric vehicle 105, determine the relative position of the reference point (e.g., reference points 610, 620, 630, and 640), reference line, reference area, or reference volume of the electric vehicle 105 relative to the position of the charging apparatus 160 (e.g., the first position 330 of the charging cable 165), and determine the relative distance between the position of the charge port 170 relative to the position of the charging apparatus 160 using the relative position 340 of the charge port 170 to the reference point, reference line, reference area, or reference volume of the electric vehicle 105 and the relative position of the reference point, reference line, reference area, or reference volume of the electric vehicle 105 relative to the position of the charging apparatus 160 (e.g., the first position 330 of the charging cable 165).

The coordinate system including the coordinate corresponding to the first position 340 of the charge port 170 and a coordinate of each of the reference points 610, 620, 630, and 640 can be normalized or merged with the coordinate system including the coordinate corresponding to the first position 330 of the charging apparatus 160 and a coordinate of each of the one or more reference points 610, 620, 630, and 640. The merged coordinate system allows the data processing system 265 to determine the distance between the first position 340 of the charge port 170 and the first position 330 of the charging apparatus 160. Vectors can be added to determine a vector from the first position 340 of the charge port 170 and the first position 330 of the charging apparatus 160, vice versa. The vectors 660 or 340 can be added to yield the vector from the first position 330 to the first position 340. The vectors 670 and 625 can be added to yield another vector from the first position 330 to the first position 340. The distance between the first position 330 and the first position 340 is the length of the combined vector. The data processing system 265 can accordingly determine the distance 550 between the charging apparatus and the charge port based on the spatial information 545 and the position 530 of charge port on the vehicle. For example,

At 440, the cable dispenser (e.g., the cable dispenser 220) can provide a length of a segment of the cable based on the distance between the charging apparatus and the charge port. The cable dispenser 220 is configured to dispense the determined length of the segment of the cable from the charging apparatus, based on at least one of the radius of the spool or spindle of the support structure 222, the number of rotations of the motor (e.g., the actuation mechanism 224) controlling the spool or spindle, a radius of each roller of the release mechanism 226, a number of rotation of each roller of the release mechanism 226, and so on. The actuation mechanism 224 is configured to release the determined length of the segment of the charging cable 165. The actuation mechanism 224 is configured to release the determined length of the segment of the cable using motor assistance. The actuation mechanism 224 or the release mechanism 226 is configured to prevent release or increase resistance of the charging cable 165 subsequent to releasing the determined length of the segment of the cable. The cable dispenser 220 provides the length of a segment of the charging cable 165 in response to detecting a dispense trigger event. The dispense trigger event includes detecting that the user has displaced a portion of the charging cable 165. For example, one or more of the charging cable 165, the release mechanism 226, or the cable dispenser 220 can include a displacement detection mechanism such as magnets, spring-loaded switches, motion sensors, and so on that can trigger a signal to be passed to the processing circuit 240 in response to sensing displacement of a portion (e.g., the electrical connector 320) of the charging cable 165. The dispense trigger event can be a predetermined time period in response to 410, 420, or 430.

The method 400 can be repeated for another electric vehicle, realizing dynamic provision of cable length per vehicle. The sensor can detect second characteristic of a second vehicle different from the first vehicle. The data processing system 265 can determine, based at least in part of the second characteristic of the second vehicle, a second position of a second charge port of the second vehicle. The data processing system 265 can determine, based at least in part on the second position of the second charge port of the second vehicle, a second distance between the charging apparatus and the second charge port of the second vehicle. The cable dispenser is configured to provide a second length of a second segment of the cable based on the distance between the charging apparatus and the second charge port.

In some examples, the charging apparatus 160 (e.g., the processing circuit 240) can establish, via the network device 250, a communication session 210 with the data processing system 265 (e.g., the one or more computing systems that are remote from the charging apparatus 160 and the electric vehicle 105). The one or more computing systems that are remote from the charging apparatus 160 and the electric vehicle 105 include at least one processor and memory as described and can determine the position 340 of the charge port 170 of the vehicle 105 in the manner described. The one or more computing systems that are remote from the charging apparatus 160 and the electric vehicle 105 can also determine, based at least in part on the position 340 of the charge port 170 of the electric vehicle 105, the distance 345 between the charging apparatus 160 and the charge port 170 of the electric vehicle 105 in the manner described.

FIG. 7 depicts an example block diagram of an example computer system 700. The computer system or computing device 700 can include or be used to implement a data processing system (e.g., the data processing system 265) or its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be used for storing information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user such as a driver of the electric vehicle 105 or other end user. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a LAN and a wide area network WAN, an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a sensor to detect a characteristic of a vehicle;
a data processing system to determine, based at least in part on the characteristic, a position of a charge port of the vehicle;
the data processing system to determine, based at least in part on the position of the charge port of the vehicle, a distance between a charging apparatus and the charge port of the vehicle; and
the charging apparatus comprising a cable dispenser, the cable dispenser to provide a length of a segment of a cable based on the distance between the charging apparatus and the charge port.

2. The system of claim 1, wherein the characteristic indicates a vehicle model, comprising:
the data processing system to determine the vehicle model of the vehicle based on the characteristic; and
the data processing system to determine the distance between the charging apparatus and the charge port of the vehicle based at least in part on the vehicle model of the vehicle.

3. The system of claim 1, wherein the characteristic indicates a vehicle model, comprising:
the data processing system to correlate the vehicle with a vehicle model based at least in part on the characteristic of the vehicle and vehicle model data obtained from a database; and
the data processing system to determine the distance between the charging apparatus and the charge port of the vehicle based at least in part on the vehicle model of the vehicle.

4. The system of claim 1, wherein the characteristic indicates spatial information of the vehicle, comprising:
the data processing system to determine the spatial information of the vehicle based at least in part of the characteristic; and
the data processing system to determine the length of the segment of the cable based at least in part on the spatial information of the vehicle.

5. The system of claim 1, comprising:
the characteristic including at least one of an image, video, Light Detection and Ranging (LIDAR) data, and spatial data; and
the sensor including at least one of a camera, an infrared sensor, a Light Detection and Ranging (LIDAR) system, and a spatial data sensor.

6. The system of claim 1, comprising:
the charging apparatus establishing a communication session with the data processing system via a network, the data processing system including at least one processor and memory to determine the position of the charge port of the vehicle based at least in part of the characteristic.

7. The system of claim 1, comprising:
a network device configured to receive from the vehicle a charging request, the charging request comprising an indication of a vehicle model of the vehicle, wherein the data processing system to determine the distance between the charging apparatus and the charge port based at least in part on the vehicle model of the vehicle.

8. The system of claim 1, comprising:
the cable dispenser configured to dispense the determined length of the segment of the cable from the charging apparatus.

9. The system of claim 1, comprising:
the charging apparatus including an actuation mechanism to release the determined length of the segment of the cable.

10. The system of claim 1, comprising at least one of:
the charging apparatus including an actuation mechanism to release the determined length of the segment of the cable using motor assistance; or
the charging apparatus including the actuation mechanism to withdraw the determined length of the segment of the cable using the motor assistance.

11. The system of claim 1, comprising:
the charging apparatus including an actuation mechanism to prevent or increase resistance for release of the cable subsequent to releasing the determined length of the segment of the cable.

12. The system of claim 1, comprising:
the sensor to detect second characteristic of second vehicle;
the data processing system:
to determine based at least in part of the second characteristic of the second vehicle a second position of a second charge port of the second vehicle;
to determine, based at least in part on the second position of the second charge port of the second vehicle, a second distance between the charging apparatus and the second charge port of the second vehicle; and
the cable dispenser to provide a second length of a second segment of the cable based on the distance between the charging apparatus and the second charge port.

13. The system of claim 1, comprising:
the cable dispenser including an actuation mechanism having at least one of a release mechanism, clamp, and lock to control dispensing of the segment of the cable with the determined length.

14. The system of claim 1, comprising:
the vehicle including a battery and the charge port connected to the battery to supply power to the battery, wherein the charging apparatus to charge the battery via the cable and the charge port.

15. A method, comprising:
detecting, with a sensor, a characteristic of a vehicle;
determining, based at least in part on the characteristic, a position of a charge port of the vehicle;
determining, based at least in part on the position of the charge port of the vehicle, a distance between a charging apparatus and the charge port of the vehicle; and
providing, using a cable dispenser, a length of a segment of the cable based on the distance between the charging apparatus and the charge port.

16. The method of claim 15 comprising:
determining a distance between an initial position of the cable and the position of the charge port of the vehicle.

17. The method of claim 15, comprising:
determining a vehicle model of the vehicle using the sensor, the characteristic of the vehicle comprises the vehicle model of the vehicle; and
determining, based at least in part on the vehicle model of the vehicle, the distance between the charging apparatus and the charge port.

18. The method of claim 15, comprising:
determining a vehicle model of the vehicle based on a charging request received from the vehicle, the characteristic of vehicle comprises the vehicle model of the vehicle; and
determining, based on the vehicle model of the vehicle, the distance between the charging apparatus and the charge port.

19. The method of claim 15, comprising:
determining spatial information of the vehicle using the sensor, the characteristic of vehicle comprises the spatial information; and
determining, based on the spatial information, the distance between the charging apparatus and the charge port.

20. A non-transitory computer-readable medium storing computer-readable instructions thereon, such that when executed, causes at a processor to:
detect, using a sensor, a characteristic of a vehicle;
determine, based at least in part of the characteristic, a position of a charge port of the vehicle;
determine, based at least in part on the position of the charge port of the vehicle, a distance between a charging apparatus and the charge port of the vehicle; and
provide, using a cable dispenser, a length of a segment of a cable based on the distance between the charging apparatus and the charge port.
